(19) United States
(12) Patent Application Publication
(10) Pub. No.: US 2009/0168719 A1
(43) Pub. Date: Jul. 2, 2009

(54) Method and apparatus for adding editable information to records associated with a transceiver device

(76) Inventor: Greg Mercurio, Campbell, CA (US)

Correspondence Address: EDELL, SHAPIRO & FINNAN, LLC, 1901 RESEARCH BOULEVARD, SUITE 400, ROCKVILLE, MD, 20850, US

(21) Appl. No.: 09/977,112

(22) Filed: Oct. 11, 2001

(51) Int. Cl. H04W 36/00

(52) U.S. Cl. 370/331

(57) ABSTRACT

Methods and apparatus for adding static information to records generated by an access point are disclosed. According to one aspect of the present invention, a wireless transceiver device that interfaces with a roaming device includes computer code for causing input information to be accepted from an external source, and a memory that includes an editable field and is arranged to store data. The computer code for causing the input information to be accepted from the source causes the input information to be stored in the editable field. The wireless transceiver device also includes computer code for causing a record associated with the roaming device to be generated. The record includes the input information stored in the editable field and the data, and the computer code for causing the record to be generated also causes the record to be stored on the memory.

### BACKGROUND OF THE INVENTION

1. Field of Invention

The present invention relates generally to data communication systems. More particularly, the present invention relates to systems and methods for providing customer defined data in records generated using remote, wireless transceiver devices.

2. Description of the Related Art

The demand for data communication services is growing at an explosive rate. Much of the increased demand is due to the fact that as the use of computing devices becomes more prevalent, the need for creating networks of computing devices such that resources may be shared between the computing devices also increases. Typically, wired networks such as local area networks (LANS) are used to enable computing devices within an organization to communicate with each other.

Many organizations which use LANs also use wireless devices that communicate with the LANs. The use of wireless devices such as personal digital assistants (PDAs) and laptop computers enables users of the devices to use the devices in different locations substantially without losing access to computing resources on a LAN. For example, a user of a laptop computer within an organization may use his or her laptop at a first location within a building, then move to a second location within the building. Although the user may physically connect the laptop computer to the LAN using a wired connection at the first and second locations, while the user is “roaming,” or moving, the laptop computer is a roaming device which may not be physically wired to the LAN.

In order to enable roaming devices to communicate with a LAN, access points are often used. Access points are arranged to interface with conventional, i.e., wired, LANs in order to effectively create a wireless LAN. FIG. 1 is a diagrammatic representation of a wireless LAN which includes access points. A wireless LAN 100 includes a wired LAN 104 which, as will be appreciated by those skilled in the art, generally includes computing devices such as clients and servers which are networked together in a wired network. LAN 104 is in communication with a router 108 across a connection 112.

Router 108 is connected to a plurality of access points 116 through wired connections 120. Access points 116 are effectively fixed devices which enable a roaming device 124 to communicate with LAN 104. That is, access pints 116 are fixed in desired locations associated with LAN 104 to support communications between roaming device 124 and LAN 104. Access points 116 may be an Aironet series access points available from Cisco Technology, Inc., of San Jose, Calif., although it should be understood that access points may be substantially any suitable access points.

Each access point 116 has a corresponding communications range 128. As shown, roaming device 124 is in communications range 128a of access point 116a. In general, the coverage associated with communications range 128a may vary widely. By way of example, communications range 128a may extend to approximately 150 feet in any direction from access point 116a. That is, communications range 128a may have a radius of approximately 150 feet as measured from access point 116a.

Roaming device 124 communicates with access point 116a in a wireless manner, i.e., using wireless communications, when roaming device 124 is in communications range 128a. Typically, roaming device 124 includes a wireless networking card which enables roaming device 123 to communicate with access points 116. When roaming device 124 is in communications range 128a and attempts to access a resource within LAN 104, e.g., a database within LAN 104, roaming device 124 uses wireless communications to communicate with access point 116a which, in turn, communicates with LAN 104 through wired connections 102a, 104 and router 108.

When roaming device 124 is in communications range 128a, access point 116a may create at least one record, e.g., a start record and a stop record, which provides details relating to the existence of roaming device 124 within communications range 128a. Information in a record generally includes identifying information pertaining to roaming device 124, a port which roaming device 124 is using for communications over, a type of service used by roaming device 124, a date and a time associated with the existence of roaming device 124 within communications range 128a, e.g., a start time in a start record or an end time in a stop record, and a serial number of access point 116a. The information that is included in a record is generally defined by the manufacturer of access point 116a. If roaming device 124 moves out of communications range 128a and into communications range 128b, access point 116b will create a record pertaining to the existence of roaming device 124 in communications range 128b.

A service provider, e.g., an organization that administers and maintains wireless LAN 100, often provides detailed record information to users who use wireless LAN 100. That is, a user of roaming device 124 is generally provided with accounting information that enables both the user and the service provider to track the activities of roaming device 124. For example, information relating to the amount of time roaming device 124 spends in communications range 128a may be provided to the user in his or her monthly usage bill. Such information may be used by the service provider to track the usage of access points 116 within LAN 100. Typically, the detailed record information is obtained by reading start records and end records created by access points 116.

Although information stored in start records and end records generally enables a service provider to provide a user with a detailed record of billing information, the information stored in the start records and end records is generally not customizable. In other words, a service provider is not able to configure the records created by access points 116, as the information stored in the records is typically determined by the manufacturer of access points 116. While a post-processing filter may be used by the service provider to eliminate some information that is stored in the records from being included in the billing information provided to the user, the service provider is not able to choose the information that is stored in the records.

In addition to not being able to select the information that is stored in the records maintained by access points 116, a service provider is also not able to add static information that is to be stored in the records. By way of example, although information pertaining to the physical location of access point 116a may be useful to a user of roaming device 124, such information is not included in the records generated by access point 116a. As such, while billing or usage information provided to the user of roaming device 124 may include a serial number of access point 116a, the location of access point 116a is not available to the user. Information pertaining to the location of access points 116 may be useful to the user, for example, for use in determining whether charges for using access points 116 are consistent with the locations of access points 116.

Therefore, what is needed are a method and an apparatus which allow a service provider to specify information which is to be stored in records generated and maintained by an access point. Specifically, what is desired is a system which enables a service provider to provide static information such as access point location information which may be included in records created by an access point.

### SUMMARY OF THE INVENTION

The present invention relates to adding static information to records generated by a wireless transceiver device such as an access point. According to one aspect of the present invention, a wireless transceiver device that interfaces with a roaming device includes computer code for causing input information to be accepted from an external source, and a memory that includes an editable field and is arranged to store data. The computer code for causing the input information to be accepted from the source causes the input information to be stored in the editable field. The wireless transceiver device also includes computer code for causing a record associated with the roaming device to be generated. The record includes the input information stored in the editable field and the data, and the computer code for causing the record to be generated also causes the record to be stored on the memory.

In one embodiment, the wireless transceiver device also includes computer code for obtaining the data when the roaming device is in communication with the wireless transceiver device. In such an embodiment, the computer code for causing the record to be generated includes computer code for causing the record to be generated when the roaming device registers with the wireless transceiver device.

An access point or, more generally, a remote wireless transceiver device, which is configured to enable a service provider who maintains the access point to specify information to be included in accounting or usage records generated using the access point allows a desired level of detail to be included in the records. For example, adding static information such as a location of the access point to accounting records enables the activities of a roaming device that utilizes the access point to be tracked more efficiently.

According to another aspect of the present invention, a transceiver device that interfaces with a first device includes means for accepting input information from an external source, means for storing data, and means for generating a record associated with the first device. The means for storing the data further includes means for storing the input information in an editable field when the means for accepting the input information provides the input information to the editable field. The record includes the input information that is stored in the editable field. In general, the means for storing the data also includes means for storing the record.

According to still another aspect of the present invention, a method for utilizing a transceiver device that has a communications range includes receiving static information into an editable field stored in memory associated with the transceiver device, and storing the static information into the editable field. When an indication that a roaming device is within the communications range is received, a record that includes information associated with the roaming device is created. Once the record is created, the static information is added to the record, and the record is stored in the database. In one embodiment, the static information is received from a source external to the transceiver device. In another embodiment the static information is information associated with a location of the transceiver device.

In accordance with yet another aspect of the present invention, a method of configuring a transceiver device includes positioning the transceiver device at a desired location, determining an address of the desired location, and storing the address in a memory field associated with the transceiver device. In one embodiment, the address includes at least one of a longitude, a latitude, and an altitude of the desired location. In another embodiment, the address is determined using a global positioning system receiver.

These and other advantages of the present invention will become apparent upon reading the following detailed descriptions and studying the various figures of the drawings.

### BRIEF DESCRIPTION OF THE DRAWINGS

The invention may best be understood by reference to the following description taken in conjunction with the accompanying drawings in which:

FIG. 1 is a diagrammatic representation of a system which includes access points.

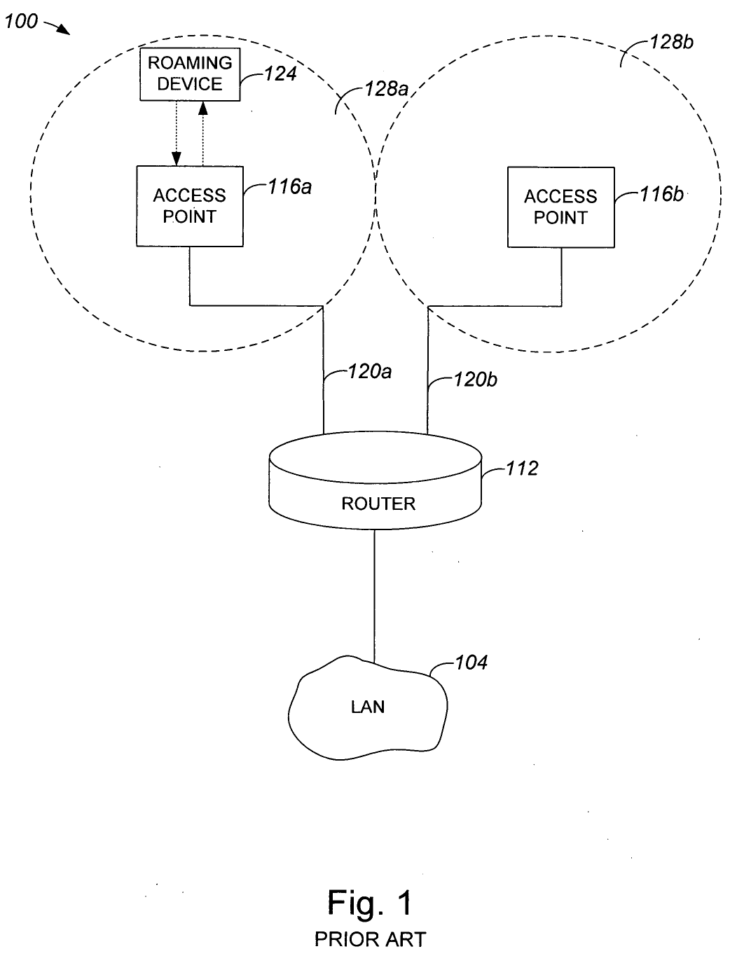

FIG. 2 is a diagrammatic representation of an access point in accordance with an embodiment of the present invention.

FIG. 3 is a process flow diagram which illustrates the steps associated with configuring an access point in accordance with an embodiment of the present invention.

FIG. 4 is a process flow diagram which illustrates the steps associated with the functioning of an access point with respect to establishing when a roaming device is within range of the access point in accordance with an embodiment of the present invention.

FIG. 5 is a diagrammatic representation of an access point with an editable field which is used to store indices in accordance with another embodiment of the present invention.

### DETAILED DESCRIPTION OF THE EMBODIMENTS

When a customer or user of a wireless local area network (LAN) roams within the wireless LAN, he or she may roam into and out of the communications range of different access points within the wireless LAN. Typically, at least one accounting or usage record which reflects a length of time a user has spent within range of a particular access point is generated. While information such as the amount of time spent within range of a particular access point is typically included in accounting records, information pertaining to physical locations of particular access points is generally not available in the accounting records. Such information, i.e., information pertaining to a physical location of a particular access point, is generally not available for inclusion in accounting records due to the fact that the information recorded by an access point is generally predetermined by a manufacturer and does not include location information. In addition, the access point is not configured to enable a service provider who obtains the access point may to add information which is to be included in the recorded information.

An access point with a text editor which allows a service provider, i.e., an owner of a LAN which includes the access point, to specify information that is to be included in accounting records provides the service provider with the ability to effectively store static information within the access point. Static information is generally information which is not updated during the operation of the access point, until an individual such as a system administrator chooses to overwrite the static information with new static information. Such static information, e.g., information pertaining to the physical location of the access point, may be stored in an editable, non-volatile text field in a database or memory associated with the access point. Allowing the service provider to provide static information to be stored on an access point enables the service provider to effectively customize accounting records, or usage records, associated with the access point. Customizing accounting records to specify a location of an access point that is accessed by a roaming device enables the owner of the roaming device to more clearly ascertain which resources, e.g., access points, he or she has made use of.

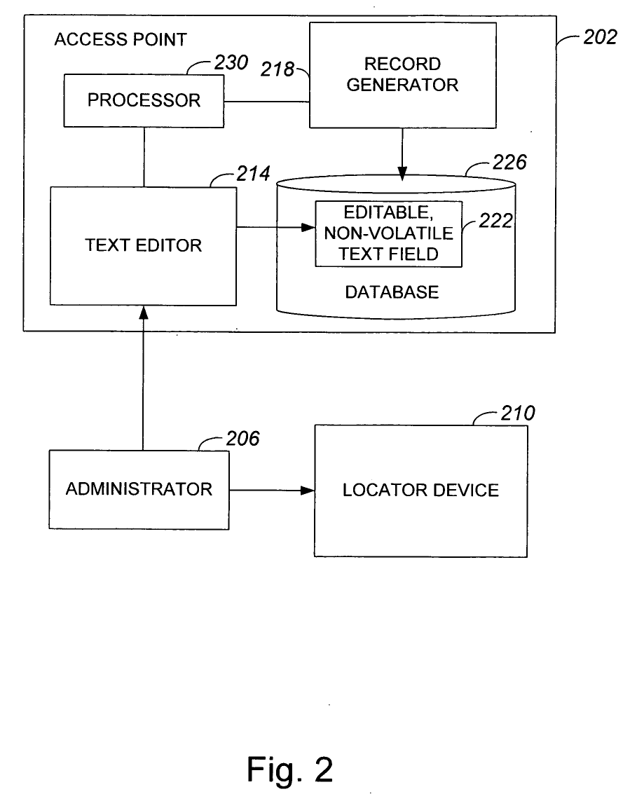

With reference to FIG. 2, the configuration of an access point, or a remote wireless transceiver device, which accepts text input, e.g., data defined by a service provider, will be described in accordance with an embodiment of the present invention. When an access point 202 is to be set up by an administrator 206 of a LAN that includes access point 202, administrator 206 may use a locator device 210 to establish a physical location of access point 202. By way of example, administrator 206 may use locator device 210 to establish a longitude, a latitude, and an altitude of access point 202. Locator device 210 may be substantially any suitable device, e.g., a global positioning system (GPS) receiver, which enables a location of access point 202 to be identified.

Access point 202 includes a text editor 214 which is arranged to accept input or information from administrator 206. In one embodiment, text editor 214 may be a software program, or computer code, which is arranged to be executed by a processor 230 and to accept text input from administrator 206 through the use of an input device such as a keypad or keyboard associated with access point 202 (not shown). The information entered using text editor 214 may be location information obtained through the use of locator device 210. It should be appreciated, however, that any suitable information may be inputted into text editor 214. Suitable information may include, but is not limited to, information which may be used by access point 202 to determine the types of information which are to be included in records generated by record generator 218 of access point 202, and information which specifies an asset number assigned to access point 202.

Information that is provided to text editor 214 by administrator 206 is stored as an editable, non-volatile text field 222 in a database 226 within access point 226. It should be appreciated that database 226 is generally a computer memory and may be, in one embodiment, a hard disk, a computer-readable tape, a floppy disk, or a CD-ROM. In addition to storing editable, non-volatile text field 222, database 226 typically also stores other information. For instance, information used by record generator 218 to generate accounting records pertaining to the usage of access point 202 is typically obtained from database 226 where the information is stored. Such information may include a user name, a date, and a time which are substantially automatically recorded when a user of a roaming device (not shown) comes into range of access point 226.

A record generated by record generator 218 which may be executed by processor 230 may be a start record which is generated when a roaming device registers with access point 202, or an end record which is generated when the roaming device is deregistered from access point 202. Such records generally include the information, or at least some representation of the information, contained within editable, non-volatile text field 222, as well as other information stored in database 226. Records generated by record generator 218 are typically also stored in database 226 until the records are needed, e.g., by a billing system of a service provider. As will be understood by those skilled in the art, record generator 218 is typically a software program, or computer code, which causes records to be created.

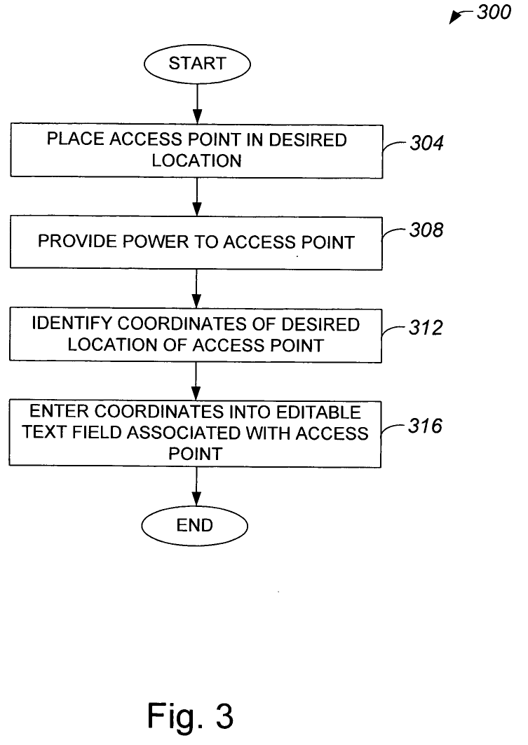

In general, when a service provider first obtains an access point, the service provider configures the access point for operation. That is, the service provider or, more specifically, a system administrator associated with the service provider, sets up the access point. FIG. 3 is a process flow diagram which illustrates the steps associated with configuring an access point in accordance with an embodiment of the present invention. A process 300 begins at step 304 in which the access point is placed at or positioned in a desired location. Once the access point is properly positioned, power may be provided to the access point in step 308.

After power has been provided to the access point, the coordinates of the location at which the access point is positioned are identified in step 312. The coordinates of the location may be identified using substantially any suitable method. By way of example, the longitude, latitude, and altitude coordinates of the location of the access point may be identified using a GPS receiver at the location at which the access point is positioned.

Once the coordinates of the location of the access point are identified, the system administrator may manually enter the coordinates into the editable text field associated with the access point in step 316. As previously mentioned, the system administrator may input the coordinates as text into the editable text field using a text editor associated with the access point. When the coordinates are entered into the editable text field, the coordinates effectively remain static in the editable text field until the system administrator manually overwrites the coordinates, e.g., to provide a new set of coordinates when the access point is to be repositioned in a different location. After the coordinates are entered into the editable text field, the process of configuring the access point is completed.

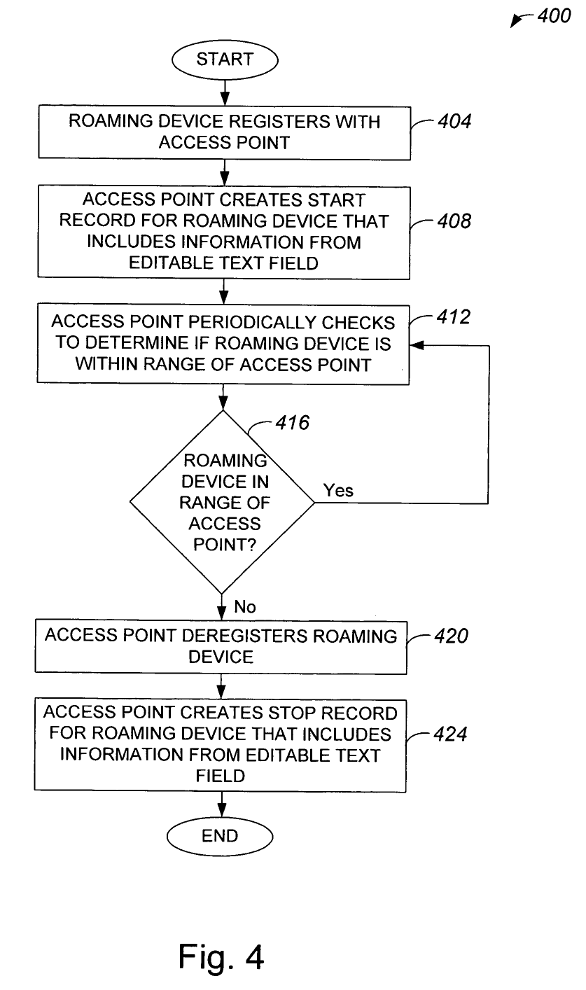

When a roaming device comes into range of an access point which has been configured, e.g., as described in FIG. 3, the roaming device and the access point communicate in order to establish that the roaming device is in range of the access point. FIG. 4 is a process flow diagram which illustrates the steps associated with the functioning of an access point with respect to establishing when a roaming device is within range of the access point in accordance with an embodiment of the present invention. A process 400 of establishing that a roaming device is within the communications range of an access point begins at step 404 in which a roaming device registers itself with the access point. Typically, when a roaming device enters the communications range of an access point, the roaming device and the access point automatically communicate such that the presence of the roaming device in the communications range is effectively acknowledged, as will be appreciated by those skilled in the art. That is, remote authentication is performed between the roaming device and the access point using substantially any suitable authentication protocol.

Once the roaming device is registered with the access point, the access point creates a start record for the roaming device in step 408. The start record is generally a data record that includes information that is automatically obtained from the roaming device when the roaming device registers with the access point. Such information may include, but is not limited to, an identifier associated with the roaming device, a port number of the access point on which communications from the roaming device are received, and a time at which the roaming device registered with the access point. In the described embodiment, the start record includes information from the editable text field, e.g. the coordinates of the access point which were entered into the editable text field when the access point was configured.

After the start record is created, the access point periodically determines if the roaming device is within its communications range in step 412. In other words, the access point periodically attempts to confirm that the roaming device is within its communications range by polling the roaming device using substantially any suitable method, as will be understood by those skilled in the art. A determination is made in step 416 regarding whether the roaming device is in the communications range of the access point. If it is determined that the roaming device is in range of the access point, then the roaming device is allowed to continue to access a network associated with the access point through the access point, and process flow returns to step 412 in which the access point periodically checks to determine if the roaming device is within range of the access point.

Alternatively, if it is determined in step 416 that the roaming device is not in range of the access point, then the indication is that the roaming device has been moved, e.g., into range of a different access point. Accordingly, in step 420, the access point deregisters the roaming device using substantially any suitable method. Once the access point deregisters the roaming device, or otherwise acknowledges that the roaming device is no longer within range of the access point, the access point creates a stop record for the roaming device in step 424. A stop record generally includes, but is not limited to including, identifying information for the roaming device, and an indication of how long the roaming device was within range of the access point, e.g., the time at which the roaming device was deregistered. In the described embodiment, the stop record also includes information read from the editable text field. After the stop record is created, the process of establishing when a roaming device is within the communications range of the access point is completed.

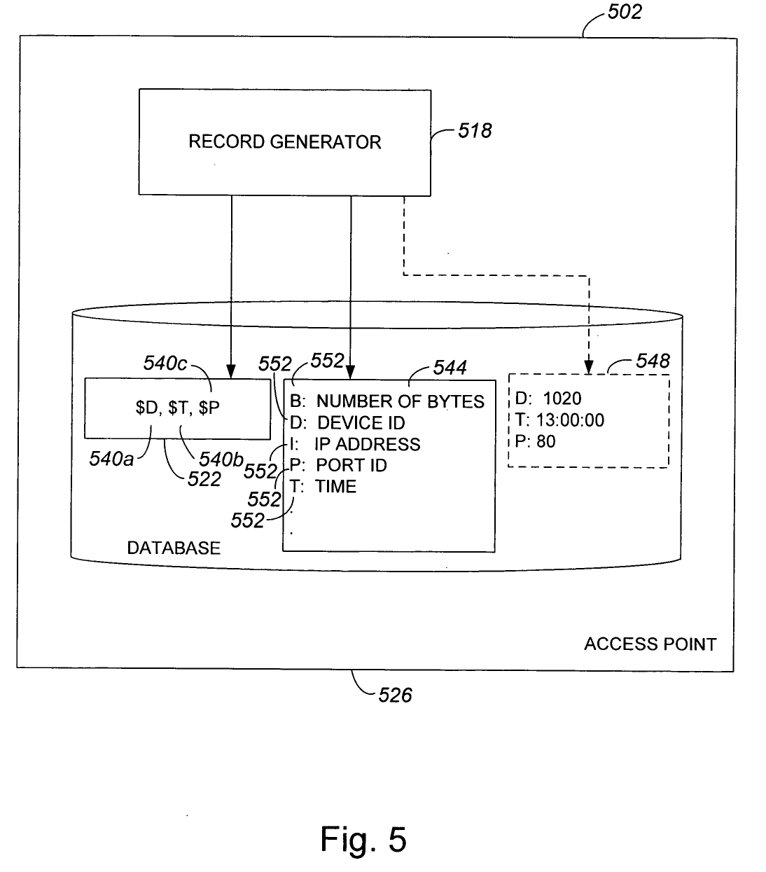

As mentioned above, in addition to storing location or identifying information in an editable field of an access point, other types of information may generally be stored in the editable field. Other types of information that may be stored include, but are not limited to, indices or identifiers which may be used to specify the contents of an accounting record. FIG. 5 is a diagrammatic representation of an access point with an editable field which is used to store indices or identifiers in accordance with an embodiment of the present invention. An access point 502 is generally similar to access point 202 of FIG. 2, and includes a record generator 518, a database 526, and an editable, non-volatile field 522 which is stored within database 526. In the described embodiment, field 522 includes indices 540 which may be input into field 522 using a text editor such as text editor 214 of FIG. 2.

Indices 540 are used by record generator 518 to index into a table 544 which is effectively a list of information types which access point 502 may obtain from a device (not shown) within its communications range. Indices 540 are provided by a system administrator to specify the contents or entries 552 of a record 548 generated and stored by record generator 518 in database 526 or, more generally, memory associated with access point 502. Although all information listed in table 544 may be included in record 548 which may then be filtered by an accounting system (not shown) to identified desired information, the use of indices 540 may substantially eliminate the need to filter information contained in record 548.

As shown, index 540a may be used by record generator 518 to specify that a device identifier (ID) for a roaming device is to be included in record 548. Index 540b specifies that a time, e.g., a time at which a roaming device registers with access point 502 or a time at which access point 502 deregisters the roaming device, is to be included in record 548, while index 540c specifies that a port number which the roaming device is using to communicate with access point 502. Indices 540 are effectively matched against entries 552 in table 544 which, typically, correspond to types of information which access point is arranged to acquire from a roaming device. Once indices 540 are matched against entries 552, information corresponding to entries 552 may be stored in record 548.

Although only a few embodiments of the present invention have been described, it should be understood that the present invention may be embodied in many other specific forms without departing from the spirit or the scope of the present invention. By way of example, substantially any static information, or information which is provided to an access point by a system administrator or other individual, may be inputted into an editable, non-volatile text field. Further, the editable, non-volatile field may be a field other than a text field. That is, the non-volatile field which accepts information from the system administrator may be configured to accept non-text information.

While an editable, non-volatile field has been described as being stored on a database that is part of an access point, such a field may instead be stored on a database that is in communication with the access point. For instance, an access point may be coupled to an external database, or a database that is not encompassed within the access point. Information provided by a system administrator may be stored on the external database, which is accessed by the access point when records are created.

An editable, non-volatile field such as an editable, non-volatile text field which is associated with an access point enables the static information stored in the field to be maintained even when power to the access point is lost. In one embodiment, in lieu of using a non-volatile field to store static information, a volatile field may be used without departing from the spirit or the scope of the present invention. When a volatile field is used to store static information such as location information within an access point, in the event that power to the access point is lost, an administrator will generally need to re-enter the static information into the volatile field once power is regained.

In addition to configuring an access point when the access point is initially set up, e.g., purchased and positioned in a desired location, it should be appreciated that the access point may be configured or reconfigured at substantially any time. For example, when the access point is to be relocated to a new location, a system administrator may input the longitude, latitude, and altitude of the new location into the editable field.

The location of an access point has generally been described as having coordinates, e.g., a longitude, a latitude, and an altitude. As described above, when location information is provided into an editable field associated with an access point, the longitude, the latitude, and the altitude of the location is inputted. It should be appreciated, however, that in lieu of identifying the coordinates of the location at which the access point is positioned, the location may be identified in a variety of other ways. For instance, the location may be identified by specifying an address at which the access point is located, e.g., a street address and a room number. Alternatively, the location may be identified by a name, e.g., “location 12,” which may be an identifier for a particular location. By way of example, “location 12” may be the identifier for a particular longitude, latitude, and altitude at which the access point is located.

The present invention may generally be applied to any suitable device. That is, an editable text field which is suitable for storing static information such as a location may be implemented with respect to devices other than access points. For instance, wireless transceiver devices other than access points may be configured include editable text fields. A router may also be configured to include an editable text field. An editable text fields in a router may be used to store location information such that the wiring closet in which the router is located may be identified in an accounting record associated with the router. Such location information may be useful, for example, to identifying a router that may be failing to support dial-in procedures.

In general, the steps associated with methods of configuring an access point and establishing when a roaming device is within range of the access point may be widely varied. Steps may be added, removed, altered, or reordered without departing from the spirit or the scope of the present invention. For example, in lieu of inputting coordinates of a location into an editable text field when an access point is being configured, an address may instead be inputted. Also, while an access point has been described as periodically determining if a roaming device is within range of the access point in step 412 of FIG. 4, the access point may instead make a determination that the roaming device is no longer in range of the access point when no signal has been received from the roaming device after a predetermined amount of time has elapsed without departing from the spirit or the scope of the present invention. Therefore, the present examples are to be considered as illustrative and not restrictive, and the invention is not to be limited to the details given herein, but may be modified within the scope of the appended claims.

1: A wireless transceiver device, the wireless transceiver device being arranged to interface with a roaming device, the wireless transceiver device comprising:
computer code stored in said wireless transceiver device, said computer code for causing static physical location input information associated with the wireless transceiver device to be accepted;
a memory arranged to store data, the memory further including an editable field, wherein the computer code for causing the static physical location input information to be accepted causes the static physical location input information to be stored in the editable field;
computer code stored in said wireless transceiver device, said computer code for causing a record associated with the roaming device to be generated, the record being arranged to include the static physical location input information stored in the editable field and the data, wherein the computer code for causing the record associated with the roaming device to be generated further causes the record to be stored on the memory; and
a processor for executing the computer codes, wherein the memory is further arranged to store the computer codes.

2: The wireless transceiver device of claim 1 further including computer code stored in said wireless transceiver device, said computer code for obtaining the data, wherein the data is obtained when the roaming device is in communication with the wireless transceiver device.

3: The wireless transceiver device of claim 2 wherein the computer code for causing the record associated with the roaming device to be generated includes computer code for causing the record associated with the roaming device to be generated when the roaming device registers with the wireless transceiver device.

4: The wireless transceiver device of claim 2 wherein the computer code for causing the record associated with the roaming device to be generated includes computer code for causing the record associated with the roaming device to be generated when the roaming device deregisters from the wireless transceiver device.

5: The wireless transceiver device of claim 1 wherein the static location input information is a location associated with the wireless transceiver device, and the computer code for causing the static physical location input information to be accepted include computer code for causing the static physical location input information to be accepted from a source that is external to the wireless transceiver device.

6: The wireless transceiver device of claim 1 wherein the wireless transceiver device is an access point.

7: A wireless transceiver device, the wireless transceiver device being arranged to interface with a first device, the transceiver device comprising:
means for accepting input information associated with the wireless transceiver device;
means for storing data, the means for storing the data further including means for storing the input information in an editable field, wherein the means for accepting the input information includes means for providing the input information to the editable field; and
means for generating a record associated with the first device, the record being arranged to include the input information stored in the editable field, wherein the means for storing the data further includes means for storing the record.

8: The wireless transceiver device of claim 7 further including means for obtaining the data, wherein the data is obtained when the first device is in communication with the wireless transceiver device.

9: The wireless transceiver device of claim 8 wherein the means for generating the record include means for generating the record when the first device registers with the wireless transceiver device.

10: The wireless transceiver device of claim 8 wherein the means for generating the record include means for generating the record when the first device deregisters from the transceiver wireless device.

11: The wireless transceiver device of claim 7 wherein the input information is a physical location associated with the wireless transceiver device.

12: The wireless transceiver device of claim 11 wherein the location includes at least one of a longitude, a latitude, and an altitude associated with the transceiver device.

13: The wireless transceiver device of claim 7 wherein the wireless transceiver device is an access point and the first device is a roaming device.

14: The transceiver wireless device of claim 13 wherein the access point is a part of a wireless local area network, the transceiver wireless device further including:
means for obtaining the data from the first device when the first device is in communication with the transceiver wireless device to access the wireless local area network.

15: The wireless transceiver device of claim 14 wherein the means for generating the record associated with the first device includes means for placing the data obtained from the first device in the record and means for placing the input information stored in the editable field in the record.

16: The wireless transceiver device of claim 15 wherein the means for generating the record further includes means for obtaining the input information from the editable field.

17: A method for utilizing a transceiver device, the transceiver device being a wireless transceiver device, the transceiver device having a communications range, the method comprising:
receiving static physical location information into an editable field stored in memory associated with the transceiver device, the static location information being information pertaining to the transceiver device;
storing the static physical location information into the editable field;
receiving an indication that a roaming device is within the communications range;
creating a record, the record being arranged to include information associated with the roaming device;
adding the static physical location information into the record; and
storing the record in the memory.

18: The method of claim 17 wherein the static physical location information is received from a source external to the transceiver device.

19: The method of claim 17 wherein the record is created after the indication that the roaming device is within the communications range is received.

20: The method of claim 17 wherein adding the static physical location information into the record includes reading the static location information from the editable field.

21. (canceled)

22: The method of claim 17 wherein the transceiver device is an access point.

23: The method of claim 17 further including:
obtaining the information associated with the roaming device when the indication that the roaming device is within the communications range is received.

24-28. (canceled)

29: A method for utilizing an access point, the access point having a communications range, the method comprising:
receiving static physical location information into an editable field stored in a memory of the access point, the static physical location information being information pertaining to the access point;
storing the static physical location information into the editable field;
receiving an indication that a roaming device is within the communications range;
registering the roaming device after the indication is received, wherein registering the roaming device includes performing a remote authentication;
creating a record after registering the roaming device, the record being arranged to include information associated with the roaming device;
obtaining the static physical location information from the editable field;
adding the static location information into the record; and
storing the record in the memory.
